(19) United States
(12) Patent Application Publication
(10) Pub. No.: US 2026/0183740 A1
(43) Pub. Date: Jul. 2, 2026

(54) POROUS CARBON SORBENT FOR CARBON DIOXIDE CAPTURE AND METHODS OF MAKING AND USING SAME

(71) Applicant: Saudi Arabian Oil Company, Dhahran (SA)

(72) Inventors: Wala Algozeeb, Al-Khobar (SA); Noha Al-Shihri, Al-Khobar (SA); Emad N. Al-Shafei, Saihat (SA)

(21) Appl. No.: 19/008,033

(22) Filed: Jan. 2, 2025

(51) Int. Cl. B01J 20/20; B01D 53/047; B01J 20/28; B01J 20/30

(52) U.S. Cl. CPC B01J 20/20; B01D 53/047; B01J 20/28061; B01J 20/28064; B01J 20/28066; B01J 20/28071; B01J 20/28073; B01J 20/2808; B01J 20/28083; B01J 20/3071; B01J 20/3078; B01D 2253/102; B01D 2253/112; B01D 2253/306; B01D 2253/308; B01D 2253/311; B01D 2257/504

(57) ABSTRACT

A method for capturing and releasing carbon dioxide (CO₂) includes contacting a nanoporous carbon (NPC) material with a CO₂-containing gas stream, thereby at least partially absorbing CO₂ in the form of molecules on surfaces and pores of the NPC material to form a sample; releasing the CO₂ from the sample by thermally heating the sample or exposing the sample to a pressure swing adsorption (PSA) unit; and collecting the CO₂. A method of making the NPC material by heating one or more low fixed carbon feeds in the presence of one or more metal salts is also disclosed.

### TECHNICAL FIELD

The present disclosure relates to methods for capturing and releasing carbon dioxide (CO₂), more particularly, to methods for capturing and releasing CO₂ using low fixed carbon feeds derived porous carbon. The present disclosure also relates to methods of making the low fixed carbon feeds derived porous carbon.

### BACKGROUND

Solid sorbents have gained interest as an alternative to aqueous amines for CO₂ removal. Traditionally, metal organic frameworks (MOFs) and zeolites have been explored as sorbents for CO₂ capture and release. However, both MOFs and zeolites are expensive and unstable due to their physical and chemical properties. Accordingly, there is a need to develop alternative sorbent materials that are stable, cost effective, and have enhanced CO₂ uptake capacity. Additionally, there is also a need to develop more efficient methods for capturing CO₂.

### SUMMARY

This disclosure describes technologies relating to methods for capturing and releasing carbon dioxide (CO₂), and methods of making low fixed carbon feeds derived porous carbon.

### BRIEF DESCRIPTION OF THE DRAWINGS

FIG. 1 is a plot of a thermogravimetric analysis (TGA) curve of a pyrolysis oil from a petroleum feedstock, according to certain embodiments of the present disclosure.

FIG. 2 is a plot of a TGA curve of a light cycle oil from a petroleum feedstock, according to certain embodiments of the present disclosure.

FIG. 3 is a plot of a nitrogen sorption isotherm curve of a pyrolysis oil from a petroleum feedstock, according to certain embodiments of the present disclosure.

FIG. 4 is a plot of a nitrogen sorption isotherm curve of a light cycle oil from a petroleum feedstock, according to certain embodiments of the present disclosure.

FIG. 5 illustrates pore size distributions of a pyrolysis oil derived porous carbon material, according to certain embodiments of the present disclosure.

FIG. 6 illustrates pore size distributions of a light cycle oil derived porous carbon material, according to certain embodiments of the present disclosure.

FIG. 7 is a scanning electron microscope (SEM) image of a pyrolysis oil derived porous carbon material, according to certain embodiments of the present disclosure.

FIG. 8 is an SEM image of a light cycle oil feedstock porous carbon material, according to certain embodiments of the present disclosure.

FIG. 9 is a plot of a CO₂ sorption isotherm curve of a pyrolysis oil derived porous carbon material, according to certain embodiments of the present disclosure.

FIG. 10 is a plot of a breakthrough curve of a pyrolysis oil derived porous carbon material and a zeolite sorbent, according to certain embodiments of the present disclosure.

FIG. 11 is a plot of a CO₂ sorption isotherm curve of a light cycle oil derived porous carbon material, according to certain embodiments of the present disclosure.

### DETAILED DESCRIPTION

In view of the foregoing, one objective of the present disclosure is to provide a method for capturing and releasing carbon dioxide (CO₂) using a nanoporous carbon (NPC) material. A second objective of the present disclosure is to provide a method of preparing the NPC material.

Provided in the present disclosure are methods for capturing and releasing CO₂ using solid sorbents, such as porous carbon derived from low fixed carbon feeds. In some embodiments, the low fixed carbon feeds are obtained from a petroleum feedstock that contains iso/normal paraffins, naphthenes, and aromatics. In some embodiments, the low fixed carbon feeds are obtained from a non-petroleum feedstock, such as a biorenewable feedstock. These porous carbon sorbents are produced in large quantities with improved stability as compared to metal organic frameworks (MOFs) and zeolites. Furthermore, the porous carbon of the present disclosure can be easily packaged, stored, and transported.

The method for capturing and releasing CO₂ includes contacting a nanoporous carbon (NPC) material with a CO₂-containing gas stream, thereby at least partially absorbing CO₂ in the form of molecules on surfaces and pores of the NPC material to form a sample. In some embodiments, the NPC material is prepared from one or more low fixed carbon feeds selected from the group consisting of a pyrolysis oil, a light cycle oil, a heavy cycle oil, an Arab light crude oil, an Arab extra light crude oil, a natural gas fluid, and mixtures thereof.

In some embodiments, the NPC material is in contact with the CO₂-containing gas stream for about 1 minutes to about 24 hours, such as about 5 minutes to about 12 hours, about 10 minutes to about 6 hours, about 20 minutes to about 4 hours, about 30 minutes to about 2 hours, about 40 minutes to about 1 hour, or about 3 minutes, about 8 minutes, about 13 minutes, about 18 minutes, about 23 minutes, about 28 minutes, about 33 minutes, about 38 minutes, about 43 minutes, about 48 minutes, about 53 minutes, or about 58 minutes.

In some embodiments, the NPC material is in contact with the CO₂-containing gas stream at a temperature of about 0 to about 40° C., such as about 3 to about 35° C., about 5 to about 30° C., about 7 to about 25° C., about 10 to about 20° C., about 12 to about 18° C., about 14 to about 16° C., or about 0° C., about 5° C., about 10° C., about 15° C., about 20° C., about 25° C., about 30° C., about 35° C., or about 40° C.

In some embodiment, the NPC material is in contact with the CO₂-containing gas stream at a pressure of about 1 to about 1000 atmospheric pressure (Po), such as about 10 to about 900 Po, about 100 to about 800 Po, about 200 to about 700 Po, about 300 to about 600 Po, about 400 to about 500 Po, or about 1 Po, about 50 Po, about 150 Po, about 250 P, about 350 P, about 450 Po, about 550 Po, about 650 Po, about 750 Po, about 850 Po, or about 950 Po.

In some embodiments, the CO₂-containing gas stream further includes an inert gas selected from the group consisting of nitrogen, argon, and helium. In some embodiments, the CO₂ is present in the CO₂-containing gas stream in a concentration of about 5 to about 99.99 vol. % based on a total volume of the CO₂-containing gas stream, such as about 10 to about 99 vol. %, about 20 to about 98 vol. %, about 30 to about 97 vol. %, about 40 to about 96 vol. %, about 50 to about 95 vol. %, about 60 to about 94 vol. %, about 70 to about 93 vol. %, about 80 to about 92 vol. %, or about 15 vol. %, about 25 vol. %, about 35 vol. %, about 45 vol. %, about 55 vol. %, about 65 vol. %, about 75 vol. %, about 85 vol. %, about 95 vol. %, or about 99 vol. % based on the total volume of the CO₂-containing gas stream.

In some embodiments, the NPC material contains about 50 to about 90 wt. % of carbon, about 10 to about 50 wt. % of oxygen, and about 0.001 to about 10 wt. % of one or more alkali metals and alkali earth metals, as determined by energy dispersive X-ray spectroscopy (EDX). In some embodiments, the EDX analysis is conducted by applying an NPC material on a copper-covered stump to form a copper-covered sample. The copper-covered sample is used to ensure proper analysis and high quality, and the image is magnified a million times.

In some embodiments, the NPC material contains about 50 to about 90 wt. % of carbon, such as about 55 to about 85 wt. % of carbon, about 60 to about 80 wt. % of carbon, about 65 to about 75 wt. % of carbon, or about 53 wt. % of carbon, about 58 wt. % of carbon, about 63 wt. % of carbon, about 68 wt. % of carbon, about 73 wt. % of carbon, about 78 wt. % of carbon, about 83 wt. % of carbon, or about 88 wt. % of carbon, as determined by EDX analysis. In some embodiments, the NPC material contains about 10 to about 50 wt. % of oxygen, such as about 15 to about 45 wt. % of oxygen, about 20 to about 40 wt. % of oxygen, about 25 to about 35 wt. % of oxygen, or about 13 wt. % of oxygen, about 18 wt. % of oxygen, about 23 wt. % of oxygen, about 28 wt. % of oxygen, about 33 wt. % of oxygen, about 38 wt. % of oxygen, about 43 wt. % of oxygen, or about 48 wt. % of oxygen, as determined by EDX analysis. In some embodiments, the NPC material contains about 0.001 to about 10 wt. % of one or more alkali metals and alkali earth metals, such as about 0.01 to about 8 wt. % of one or more alkali metals and alkali earth metals, about 0.1 to about 6 wt. % of one or more alkali metals and alkali earth metals, about 0.5 to about 4 wt. % of one or more alkali metals and alkali earth metals, about 1 to about 3 wt. % of one or more alkali metals and alkali earth metals, or about 0.05 wt. % of one or more alkali metals and alkali earth metals, about 0.5 wt. % of one or more alkali metals and alkali earth metals, about 1.5 wt. % of one or more alkali metals and alkali earth metals, about 2.5 wt. % of one or more alkali metals and alkali earth metals, about 3.5 wt. % of one or more alkali metals and alkali earth metals, about 4.5 wt. % of one or more alkali metals and alkali earth metals, about 5.5 wt. % of one or more alkali metals and alkali earth metals, about 6.5 wt. % of one or more alkali metals and alkali earth metals, about 7.5 wt. % of one or more alkali metals and alkali earth metals, about 8.5 wt. % of one or more alkali metals and alkali earth metals, or about 9.5 wt. % of one or more alkali metals and alkali earth metals, as determined by EDX analysis.

In some embodiments, the one or more alkali metals and alkali earth metals are selected from the group consisting of lithium, sodium, potassium, rubidium, cesium, francium, beryllium, magnesium, calcium, strontium, barium, radium, and mixtures thereof. In further embodiments, the one or more alkali metals and alkali earth metals are potassium, sodium, and calcium. In further embodiments, the one or more alkali metals and alkali earth metals are potassium.

In some embodiments, the NPC material contains about 50 to about 90 wt. % of carbon, such as about 55 to about 85 wt. % of carbon, about 60 to about 80 wt. % of carbon, about 65 to about 75 wt. % of carbon, or about 53 wt. % of carbon, about 58 wt. % of carbon, about 63 wt. % of carbon, about 68 wt. % of carbon, about 73 wt. % of carbon, about 78 wt. % of carbon, about 83 wt. % of carbon, or about 88 wt. % of carbon; about 10 to about 50 wt. % of oxygen, such as about 15 to about 45 wt. % of oxygen, about 20 to about 40 wt. % of oxygen, about 25 to about 35 wt. % of oxygen, or about 13 wt. % of oxygen, about 18 wt. % of oxygen, about 23 wt. % of oxygen, about 28 wt. % of oxygen, about 33 wt. % of oxygen, about 38 wt. % of oxygen, about 43 wt. % of oxygen, or about 48 wt. % of oxygen; and about 0.001 to about 10 wt. % of potassium, such as about 0.01 to about 8 wt. % of potassium, about 0.1 to about 6 wt. % of potassium, about 0.5 to about 4 wt. % of potassium, about 1 to about 3 wt. % of potassium, or about 0.05 wt. % of potassium, about 0.5 wt. % of potassium, about 1.5 wt. % of potassium, about 2.5 wt. % of potassium, about 3.5 wt. % potassium, about 4.5 wt. % potassium, about 5.5 wt. % potassium, about 6.5 wt. % potassium, about 7.5 wt. % potassium, about 8.5 wt. % potassium, or about 9.5 wt. % of potassium. In further embodiments, the NPC material contains about 60 to about 80 wt. % of carbon, about 20 to about 40 wt. % of oxygen, and about 2 to about 8 wt. % of potassium. In further embodiments, the NPC material contains about 60 to about 70 wt. % of carbon, about 25 to about 35 wt. % of oxygen, and about 3 to about 7 wt. % of potassium. In further embodiments, the NPC material contains about 64.4 wt. % of carbon, about 30.2 wt. % of oxygen, and about 5.4 wt. % of potassium.

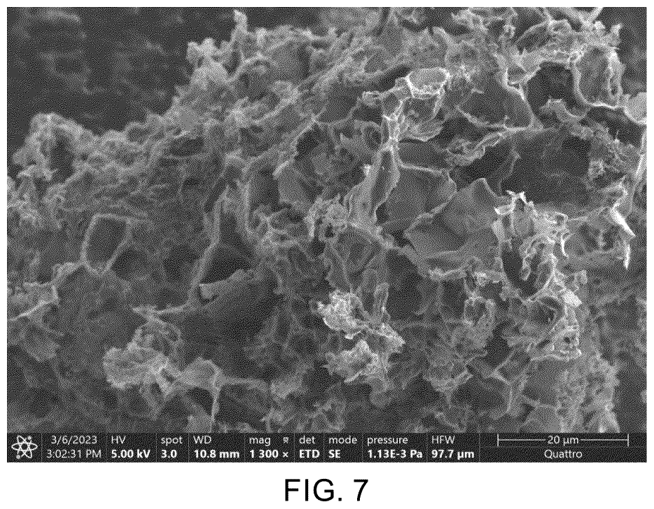

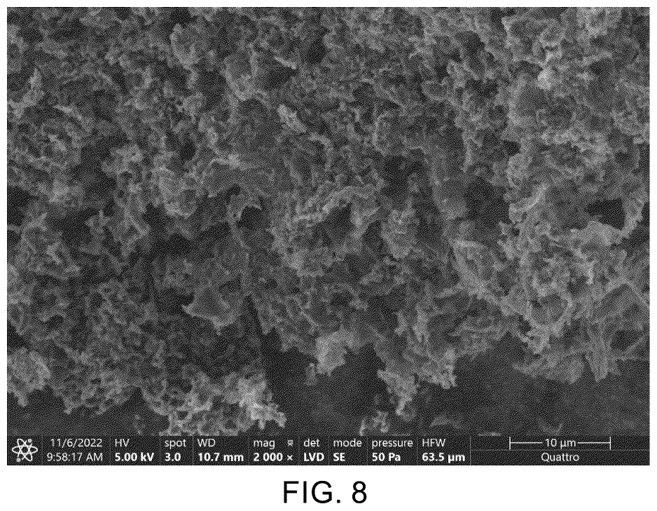

In some embodiments, the NPC material has a hierarchical pore structure. In some embodiments, the hierarchical pore structure of the NPC material contains mesopores and nanopores, such as shown in FIGS. 7 and 8. In some embodiments, the NPC material has a Barrett-Joyner-Halenda (BJH) pore size of about 0.5 nanometers (nm) to about 5 nm, such as about 0.7 nm to about 4 nm, about 0.9 nm to about 3 nm, about 1.1 nm to about 2 nm, or about 1.3 nm to about 1.5 nm, such as about 0.6 nm, about 0.8 nm, about 1.0 nm, about 1.2 nm, about 1.4 nm, about 1.6 nm, about 1.8 nm, about 2.0 nm, about 2.5 nm, about 3.5 nm, or about 4.5 nm. Also referring to FIGS. 7 and 8, the hierarchical pore structure of the NPC material also contains a plurality of interconnected nanosheets growing perpendicular to a surface of the hierarchical pore structure. In some embodiments, the NPC material has a BJH pore size of about 1.424 nm. In some embodiments, the NPC material has a BJH pore size of about 1.432 nm. In some embodiments, the mesopores and nanopores of the hierarchical pore structure of the NPC material can be a substantially uniform shape. In some embodiments, the mesopores and nanopores of the hierarchical pore structure of the NPC material can be a non-uniform shape.

In some embodiments, the plurality of interconnected nanosheets have an average width of about 2 to about 18 micrometers (μm), such as about 3 to about 17 μm, about 4 to about 16 μm, about 5 to about 15 μm, about 6 to about 14 μm, about 7 to about 13 μm, about 8 to about 12 μm, about 9 to about 11 μm, or about 10 μm. In further embodiments, the plurality of interconnected nanosheets have an average width of about 2.5 to about 5.5 μm. In further embodiments, the plurality of interconnected nanosheets have an average width of about 5.5 to about 8.5 μm. In further embodiments, the plurality of interconnected nanosheets have an average width of about 8.5 to about 11.5 μm. In further embodiments, the plurality of interconnected nanosheets have an average width of about 11.5 to about 14.5 μm. In further embodiments, the plurality of interconnected nanosheets have an average width of about 14.5 to about 17.5 μm.

In some embodiments, the plurality of interconnected nanosheets have an average thickness of about 0.5 to about 100 nm, such as about 1 to about 80 nm, about 3 to about 60 nm, about 5 to about 40 nm, about 7 to about 20 nm, or about 5 nm, about 10 nm, about 15 nm, about 20 nm, about 25 nm, about 30 nm, about 35 nm, about 40 nm, about 40 nm, about 45 nm, about 50 nm, about 55 nm, about 60 nm, about 65 nm, about 70 nm, or about 75 nm. In further embodiments, the plurality of interconnected nanosheets has an average thickness of about 10 to about 80 nm. In further embodiments, the plurality of interconnected nanosheets has an average thickness of about 10 to about 70 nm. In further embodiments, the plurality of interconnected nanosheets has an average thickness of about 10 to about 60 nm. In further embodiments, the plurality of interconnected nanosheets has an average thickness of about 10 to about 50 nm. In further embodiments, the plurality of interconnected nanosheets has an average thickness of about 10 to about 40 nm. In further embodiments, the plurality of interconnected nanosheets has an average thickness of about 10 to about 30 nm. In further embodiments, the plurality of interconnected nanosheets has an average thickness of about 10 to about 20 nm.

In some embodiments, the NPC material has an average pore volume of about 0.1 to about 1.5 milliliters per gram (mL/g), such as about 0.15 to about 1.3 mL/g, about 0.2 to about 1.1 mL/g, about 0.25 to about 0.9 mL/g, about 0.3 to about 0.7 mL/g, about 0.35 to about 0.5 mL/g, about 0.4 to about 0.45 mL/g, or about 0.18 mL/g, about 0.23 mL/g, about 0.28 mL/g, about 0.33 mL/g, about 0.38 mL/g, about 0.43 mL/g, about 0.48 mL/g, about 0.53 mL/g, about 0.58 mL/g, about 0.63 mL/g, about 0.68 mL/g, about 0.73 mL/g, about 0.78 mL/g, or about 0.83 mL/g. In some embodiments, the NPC material has an average pore volume of about 0.498 mL/g. In some embodiments, the NPC material has an average pore volume of about 0.5465 mL/g.

In some embodiments, the NPC material has a Brunauer-Emmett-Teller (BET) surface area of about 200 to about 1500 square meters per gram (m²/g), such as about 250 to about 1400 m²/g, about 300 to about 1300 m²/g, about 350 to about 1200 m²/g, about 400 to about 1100 m²/g, about 450 to about 1000 m²/g, about 500 to about 900 m²/g, about 550 to about 800 m²/g, about 600 to about 700 m²/g, or about 270 m²/g, about 370 m²/g, about 470 m²/g, about 570 m²/g, about 670 m²/g, about 770 m²/g, about 870 m²/g, or about 970 m²/g. In some embodiments, the NPC material has a BET surface area of about 879.8 m²/g. In some embodiments, the NPC material has a BET surface area of about 671.6 m²/g.

In some embodiments, the NPC material has an external surface area of about 30 to about 400 m²/g, such as about 40 to about 350 m²/g, about 50 to about 300 m²/g, about 60 to about 250 m²/g, about 70 to about 200 m²/g, about 80 to about 150 m²/g, about 90 to about 100 m²/g, or about 35 m²/g, about 45 m²/g, about 55 m²/g, about 65 m²/g, about 75 m²/g, about 85 m²/g, about 95 m²/g, about 105 m²/g, about 115 m²/g, about 125 m²/g, about 135 m²/g, about 145 m²/g, about 155 m²/g, about 165 m²/g, about 175 m²/g, about 185 m²/g, about 195 m²/g, about 205 m²/g, about 215 m²/g, about 225 m²/g, about 235 m²/g, about 245 m²/g, about 255 m²/g, about 265 m²/g, about 275 m²/g, about 285 m²/g, about 295 m²/g, about 305 m²/g, about 315 m²/g, about 325 m²/g, about 335 m²/g, about 345 m²/g, about 355 m²/g, about 365 m²/g, about 375 m²/g, about 385 m²/g, or about 395 m²/g. In some embodiments, the NPC material has an external surface area of about 80.04 m²/g. In some embodiments, the NPC material has an external surface area of about 194.4 m²/g.

In some embodiments, the NPC material has a micropore surface area of about 200 to about 1500 m²/g, such as about 250 to about 1400 m²/g, about 300 to about 1300 m²/g, about 350 to about 1200 m²/g, about 400 to about 1100 m²/g, about 450 to about 1000 m²/g, about 550 to about 900 m²/g, about 600 to about 800 m²/g, about 650 to about 700 m²/g, or about 270 m²/g, about 370 m²/g, about 470 m²/g, about 570 m²/g, about 670 m²/g, about 770 m²/g, about 870 m²/g, about 970 m²/g, about 1070 m²/g, about 1170 m²/g, about 1270 m²/g, about 1370 m²/g, or about 1470 m²/g. In some embodiments, the NPC material has a micropore surface area of about 477.2 m²/g. In some embodiments, the NPC material has a micropore surface area of about 799.8 m²/g.

The carbon dioxide (CO₂) uptake capacity is determined by Equation 1,

$$Carbon Dioixde Uptake Capacity = \frac{{m}_{wet} - {m}_{dry}}{{m}_{dry}} \times 100 \% \qquad ( Eq 1 )$$

in which, m_{wet} is the mass of the NPC material after CO₂ absorption, while m_{dry} is the initial mass of the NPC material in dry powders.

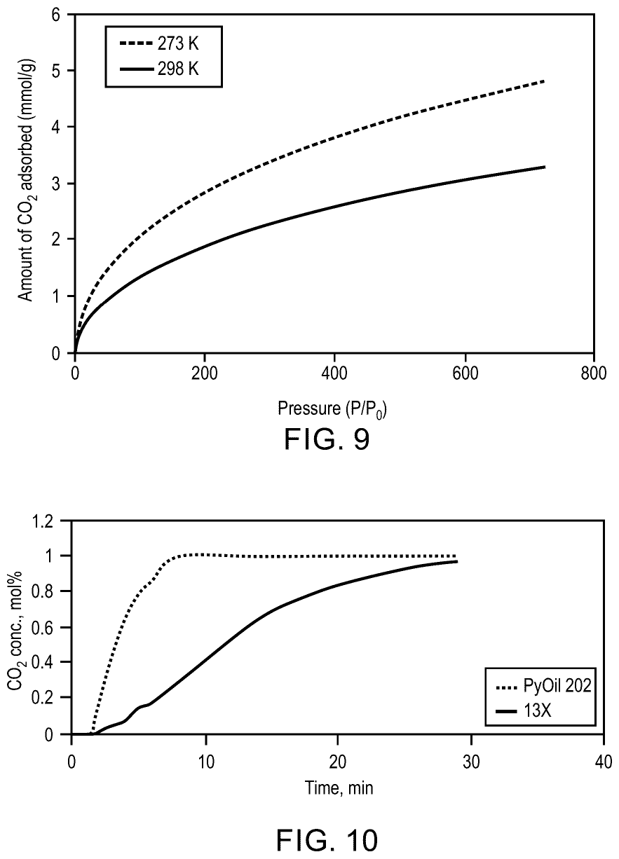

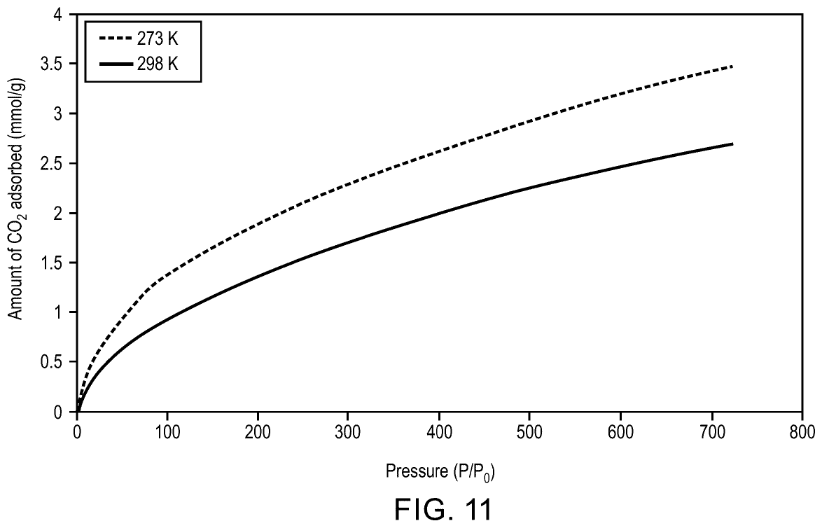

In some embodiments, the NPC material has a CO₂ uptake capacity of about 0.01 to about 10 millimoles of CO₂ per gram of the NPC material (mmol/g) at a temperature of about 0° C. and a pressure of about 0 to about 800 Po, such as shown in FIGS. 9 and 11. In some embodiments, the NPC material has a CO₂ uptake capacity of about 0.1 to about 6 mmol/g, such as about 0.5 to about 5.5 mmol/g, about 1 to 5 mmol/g, about 1.5 to about 4.5 mmol/g, about 2 to about 4 mmol/g, about 2.5 to about 3.5 mmol/g, or about 3 mmol/g at a temperature of about 0° C. and a pressure of about 0 to about 800 Po. In some embodiments, the NPC material has a CO₂ uptake capacity of about 2.5 to about 5 mmol/g at a temperature of about 0° C. and a pressure of about 600 Po. In some embodiments, the NPC material has a CO₂ uptake capacity of about 0.01 to about 10 millimoles of CO₂ per gram of the NPC material (mmol/g) at a temperature of about 25° C. and a pressure of about 0 to about 800 Po, such as shown in FIGS. 9 and 11. In some embodiments, the NPC material has a CO₂ uptake capacity of about 0.1 to about 4 mmol/g, such as about 0.5 to about 3.5 mmol/g, about 1 to 3 mmol/g, about 1.5 to about 2.5 mmol/g, about 2 to about 2.5 mmol/g, or about 2 mmol/g at a temperature of about 25° C. and a pressure of about 0 to about 800 Po. In some embodiments, the NPC material has a CO₂ uptake capacity of about 2 to about 3.5 mmol/g at a temperature of about 25° C. and a pressure of about 600 Po. In some embodiments, the NPC material has a CO₂ uptake capacity of about 3.2 mmol/g at a temperature of about 25° C.

In some embodiments, the NPC material has less than about 5 wt. % of weight loss based on an initial weight of the NPC material at a temperature of up to about 500° C. in an oxygen atmosphere, such as up to about 450° C., up to about 400° C., up to about 350° C., up to about 300° C. up to about 250° C., or up to about 200° C. in an oxygen atmosphere. In some embodiments, the NPC material has less than about 4.5 wt. % of weight loss, such as less than about 4 wt. % of weight loss, less than about 3.5 wt. % of weight loss, less than about 3 wt. % of weight loss, less than about 2.5 wt. % of weight loss, less than about 2 wt. % of weight loss, less than about 1.5 wt. % of weight loss, less than about 1 wt. % of weight loss, less than about 0.5 wt. % of weight loss, or less than about 0.1 wt. % of weight loss at a temperature of up to about 400° C. in an oxygen atmosphere.

In some embodiments, the method further includes releasing the CO₂ from the sample by thermally heating the sample or exposing the sample to a pressure swing adsorption (PSA) unit; and collecting the CO₂. The sample is firstly placed into a reactor. The adsorbed CO₂ is desorbed from the NPC material by changing the reactor temperature or pressure based upon the characteristics of the NPC material. In one embodiment, the reactor pressure is varied in a pressure swing adsorption (PSA) process for CO₂ desorption. In one embodiment, the reactor temperature is varied in a temperature swing adsorption (TSA) process.

In some embodiments, the thermally heating the sample is carried out at a temperature of about 30 to about 150° C., such as about 35 to about 145° C., about 40 to about 140° C., about 45 to about 135° C., about 50 to about 130° C., about 55 to about 125° C., about 60 to about 120° C., about 65 to about 115° C., about 70 to about 110° C., about 75 to about 105° C., about 80 to about 100° C., about 85 to about 95° C., or about 90° C., thereby releasing the CO₂ from the NPC material. In some embodiments, the sample is heated at a temperature of about 50° C. to release the CO₂ from the NPC material. In some embodiments, the sample is heated at a temperature of about 70° C. to release the CO₂ from the NPC material. In some embodiments, the sample is heated at a temperature of about 90° C. to release the CO₂ from the NPC material. In some embodiments, the sample is heated at a temperature of about 110° C. to release the CO₂ from the NPC material.

In some embodiments, the exposing the sample to the PSA unit is carried out under a reduced pressure condition, thereby releasing the CO₂ from the NPC material. In some embodiments, the pressure of the PSA unit is reduced by at least about 10% based on an initial pressure of the unit. In some embodiments, the pressure of the PSA unit is reduced by at least about 15%, such as by at least about 20%, by at least about 25%, by at least about 30%, by at least about 35%, by at least about 40%, by at least about 45%, by at least about 50%, by at least about 55%, by at least about 60%, by at least about 65%, by at least about 70%, by at least about 75%, by at least about 80%, by at least about 85%, by at least about 90%, or by at least about 95% based on the initial pressure of the unit.

Also provided in the present disclosure is a method of preparing the NPC material. The method of preparing the NPC material includes mixing the one or more low fixed carbon feeds and one or more metal salts to form a mixture.

In some embodiments, the one or more low fixed carbon feeds include, but are not limited to, a pyrolysis oil (pyoil), a light cycle oil, a heavy cycle oil, an Arab light crude oil, an Arab extra light crude oil, a natural gas fluid.

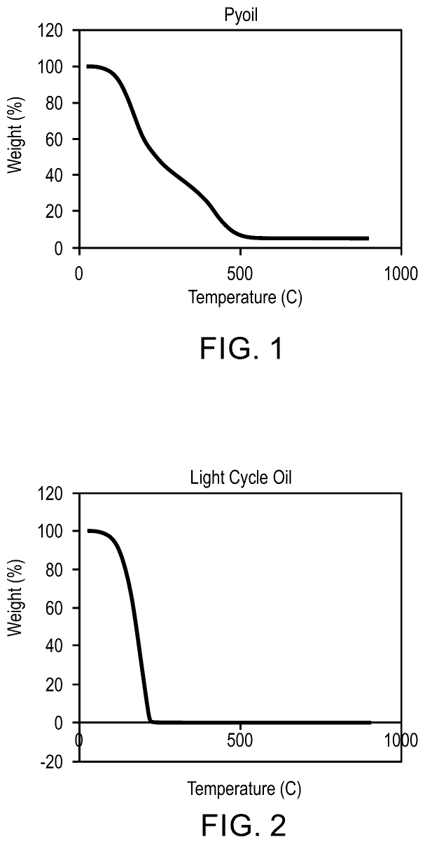

In some embodiments, the pyrolysis oil has a weight loss of about 30 to 60 wt. %, such as about 35 to about 55 wt. %, about 40 to about 50 wt. %, or about 45 wt. % at a temperature of about 200 to 300° C., such as about 225 to about 275° C., or about 250° C., as determined by thermogravimetric analysis (TGA) and depicted in FIG. 1. In some embodiments, the pyrolysis oil has a weight loss of about 50 to 95 wt. %, such as about 60 to about 90 wt. %, about 70 to about 85 wt. %, or about 85 wt. % at a temperature of about 300 to 800° C., such as about 500 to about 600° C., or about 550° C., as determined by TGA and depicted in FIG. 1. In one embodiment, the pyrolysis oil is a feed produced from waste streams including plastic waste.

In some embodiments, the light cycle oil (LCO) has a weight loss of about 90 to 99 wt. %, such as about 92 to about 99 wt. %, about 94 to about 99 wt. %, or about 99 wt. % at a temperature of about 180 to 300° C., such as about 200 to about 250° C., or about 220° C., as determined by TGA and depicted in FIG. 2. The LCO is a light fraction produced from the fluid catalytic cracker (FCC) reactor that keeps cycling without reaction. In some embodiments, the LCO has a specific gravity of about 0.94 to about 0.96, such as about 0.942 to about 0.958, about 0.944 to about 0.956, about 0.946 to about 0.954, about 0.948 to about 0.952, or about 0.950. In some embodiments, the LCO has a specific gravity of about 0.950. In some embodiments, the LCO has a carbon content of about 0.1 to about 8 wt. %, such as about 0.3 to about 6 wt. %, about 0.5 to about 4 wt. %, about 0.7 to about 2 wt. %, or about 0.9 to 1 wt. %, based on the total weight of the LCO. In some embodiments, the LCO has a carbon number of about 10 to about 22, such as about 12 to about 20, about 14 to about 18, or about 16. In some embodiments, the LCO has a double bond equivalent (DBE) value of about 5 to 12, such as about 6 to about 11, about 7 to about 10, or about 8 to about 9.

In some embodiments, the heavy cycle oil (HCO) has a weight loss of about 80 to 95 wt. %, such as about 85 to about 95 wt. %, about 90 to about 95 wt. %, or about 90 wt. % at a temperature of about 300 to 600° C., such as about 350 to about 500° C., or about 400° C., as determined by TGA. The HCO is an intermediate fraction produced from the fluid catalytic cracker (FCC) that is high in aromatic content. In some embodiments, the HCO has a specific gravity of about 1.00 to about 1.02, such as about 1.002 to about 1.018, about 1.004 to about 1.016, about 1.006 to about 1.014, about 1.008 to about 1.012, or about 1.01. In some embodiments, the HCO has a specific gravity of about 1.01. In some embodiments, the HCO has a carbon content of about 1 to about 9 wt. %, such as about 3 to about 8 wt. %, about 5 to about 7 wt. %, about 6 to about 7 wt. %, or about 6.5 wt. %, based on the total weight of the HCO. In some embodiments, the HCO has a carbon number of about 10 to about 24, such as about 12 to about 23, about 14 to about 22, about 16 to about 21, or about 17 to about 20. In some embodiments, the HCO has a DBE value of about 4 to 16, such as about 6 to about 15, about 8 to about 14, or about 10 to about 13.

In some embodiments, the Arab light crude oil (hereafter referred to as “AR” or “AL”) has a specific gravity of about 0.88 to about 0.90, such as about 0.882 to about 0.898, about 0.884 to about 0.896, about 0.886 to about 0.894, about 0.888 to about 0.892, or about 0.890. The AR (or AL) is straight Arab light crude without any processing or refining. In some embodiments, the AR has a carbon content of about 0.1 to about 8 wt. %, such as about 0.3 to about 6 wt. %, about 0.5 to about 4 wt. %, about 0.7 to about 2 wt. %, or about 0.9 to 1 wt. %, based on the total weight of the AR. In some embodiments, the AR has a carbon number of about 4 to about 40, such as about 5 to about 30, about 6 to about 20, or about 7 to about 10. In some embodiments, the AR has a DBE value of about 0 to 15, such as about 0 to about 10, about 1 to about 5, or about 2 to about 3.

In some embodiments, the natural gas fluid has a specific gravity of about 0.55 to about 0.70, such as about 0.57 to about 0.68, about 0.59 to about 0.66, about 0.61 to about 0.64, or about 0.62 to about 0.63. The natural gas fluid contains a mixture of methane (CH₄), ethane (C₂H₆), propane (C₃H₈), and butane (C₄H₁₀). In some embodiments, the natural gas fluid has a carbon content of about 1 to 4, such as about 1.1 to about 3.5, about 1.2 to about 3, about 1.3 to about 2.5, about 1.4 to about 2, or about 1.5 to about 1.8, or about 1.6.

In some embodiments, the one or more metal salts are compounds having a formula X-Y, in which X is a metal cation selected from the group consisting of potassium, calcium, and sodium, and Y is an anion selected from the group consisting of fluoride, chloride, bromide, acetate oxalate, carbonate, and bicarbonate. In further embodiments, the one or more metal salts include, but are not limited to, potassium carbonate, potassium bicarbonate, potassium chloride, calcium carbonate, calcium bicarbonate, calcium chloride, sodium carbonate, sodium bicarbonate, and sodium chloride. In some embodiments, the one or more metal salts are potassium carbonate and potassium chloride. In some embodiments, the one or more metal salts are potassium carbonate.

In some embodiments, a weight ratio of the one or more low fixed carbon feeds and the one or more metal salts is in a range of about 20:1 to about 1:10. In some embodiments, the weight ratio of the one or more low fixed carbon feeds and the one or more metal salts is in a range of about 10:1 to about 1:5, such as about 9:1 to about 1:4, about 8:1 to about 1:3, about 7:1 to about 1:2, about 6:1 to about 1:2, about 5:1 to about 1:2, about 4:1 to about 1:2, about 3:1 to about 1:2, about 2:1 to about 1:2, or about 1:2. In further embodiments, the weight ratio of the one or more low fixed carbon feeds and the one or more metal salts is about 1:2.

In some embodiments, the one or more low fixed carbon feeds contain the pyrolysis oil. In some embodiments, the one or more low fixed carbon feeds contain the light cycle oil. In some embodiments, the one or more low fixed carbon feeds contain the pyrolysis oil and the light cycle oil. In some embodiments, the pyrolysis oil is present in the one or more low fixed carbon feeds in an amount of about 10 to about 90 wt. %, such as about 15 to about 85 wt. %, about 20 to about 80 wt. %, about 25 to about 75 wt. %, about 30 to about 70 wt. %, about 35 to about 65 wt. %, about 40 to about 60 wt. %, about 45 to about 55 wt. %, or about 50 wt. % based on a total weight of the one or more low fixed carbon feeds. In some embodiments, the light cycle oil is present in the one or more low fixed carbon feeds in an amount of about 10 to about 90 wt. %, such as about 15 to about 85 wt. %, about 20 to about 80 wt. %, about 25 to about 75 wt. %, about 30 to about 70 wt. %, about 35 to about 65 wt. %, about 40 to about 60 wt. %, about 45 to about 55 wt. %, or about 50 wt. % based on the total weight of the one or more low fixed carbon feeds.

The method of preparing the NPC material further includes heating the mixture at a temperature of about 400 to about 800° C. in an inert atmosphere to form a crude material; and washing the crude material with water and drying. In some embodiments, the mixture is heated at a temperature of about 450 to about 800° C., such as about 500 to about 750° C., about 550 to about 700° C., about 600 to about 650° C., or about 600° C. in the inert atmosphere. In further embodiments, the mixture is heated at a temperature of about 600 to about 700° C. in the inert atmosphere. In some embodiments, the crude product is washed by water for at least 2 times, such as at least 4 times, at least 8 times, or at least 16 times until the one or more metal salts are removed from the crude material, thereby forming a washed material and a wash solution containing the one or more metal salts. In some embodiments, the washed material is dried using heating appliances such as ovens, microwaves, autoclaves, hot plates, heating mantles and tapes, oil baths, salt baths, sand baths, air baths, hot-tube furnaces, and hot-air guns, at a temperature of about 60 to about 120° C., such as about 70 to about 110° C., about 80 to about 100° C., or about 90 to about 100° C., to remove the water and regenerate the one or more metal salts.

### EXAMPLES

The following examples demonstrate methods for capturing and releasing carbon dioxide (CO₂) using a nanoporous carbon (NPC) material, as described herein. The examples are provided solely for illustration and are not to be construed as limitations of the present disclosure, as many variations thereof are possible without departing from the spirit and scope of the present disclosure.

### Example 1: General Procedure

The NPC materials were prepared using one or more low fixed carbon feeds and/or combined with one or more metal salts, followed by carbonization. The selected low fixed carbon feeds can be obtained from low-value streams of a refinery, such as pyrolysis oil and light cycle oil. Furthermore, the one or more low fixed carbon feeds were tested to characterize their abilities and explore their applications in the carbonization route for converting crude oil into solid carbon. The carbonization reaction was performed under a nitrogen atmosphere at a heating temperature of about 600° C. to prevent the oxidation of nanoporous carbons shown in FIGS. 7-8. The reaction was monitored, and after the reaction was completed, it was washed with water to remove the metal salts from the NPC material. The NPC material was then dried in an oven for overnight to remove residual water. On the other hand, the wash solution containing the washed water and the metal salts was heated to evaporate water from the wash solution, thereby regenerating the metal salts to be recovered for future use.

### Example 2: Preparation of Nanoporous Carbon Material from Pyrolysis Oil (Pyoil Derived NPC)

A pyrolysis oil derived NPC (pyoil derived NPC) material was prepared from pyrolysis oil in the presence of potassium carbonate and potassium chloride, followed by carbonization. 1 g of pyrolysis oil was mixed with 1 g of potassium carbonate and 1 g of potassium chloride to form a mixture, which was then subjected to the carbonization reaction. The mixture was heated at 600° C. under a nitrogen atmosphere to form a crude carbon sorbent. Once cooled, the crude carbon sorbent was washed with water to form the pyoil derived NPC material and a washed solution containing potassium carbonate. The potassium carbonate was recovered from the washed solution using techniques known to those of skill in the art.

### Example 3: Preparation of Nanoporous Carbon Material from Light Cycle Oil (LCO Derived NPC)

A light cycle oil derived NPC (LCO derived NPC) material was prepared from pyrolysis oil in the presence of potassium carbonate and potassium chloride, followed by carbonization. 1 g of light cycle oil was mixed with 1 g of potassium carbonate and 1 g of potassium chloride to form a mixture, which was then subjected to the carbonization reaction. The mixture was heated at 600° C. under a nitrogen atmosphere to form a crude carbon sorbent. Once cooled, the crude carbon sorbent was washed with water to form the LCO derived NPC material and a washed solution containing potassium carbonate. The potassium carbonate was recovered from the washed solution using techniques known to those of skill in the art.

### Example 4: Characterization of the Low Fixed Carbon Feeds

Thermogravimetric analysis (TGA) tests were performed to characterize the selected low fixed carbon feeds without the presence of metal salts as carbonization agents, as shown in FIGS. 1 and 2. The selected low fixed carbon feeds include, but are not limited to, pyrolysis oil and light cycle oil. The results demonstrated that the low fixed carbon feeds contain less than 10% fixed carbon by total weight. The carbonization agent promotes the formation of nanoporous carbon during the carbonization process, compared to the thermal cracking method of producing a carbon material. As shown in FIG. 1, the pyrolysis oil has a weight loss of about 30 to 60 wt. % at a temperature of about 200 to 300° C., and a weight loss of about 50 to 95 wt. % at a temperature of about 300 to 800° C., such as about 500 to about 600° C., or about 550° C., as determined by TGA. As shown in FIG. 2, the light cycle oil (LCO) has a weight loss of about 90 to 99 wt. % at a temperature of about 180 to 300° C., as determined by TGA.

### Example 5: Characterization of the NPC Materials

The thermal stability of NPC materials was tested under both air and inert atmosphere conditions. The results showed that the NPC materials are stable under oxygen free and/or oxygen deficient environment, such as a N₂ atmosphere. No substantial weight loss or chemical degradation were observed at a temperature of up to 600° C. However, when exposed to atmospheric air, the NPC material began decomposing at about 400° C. The scanning electron microscope (SEM) images of the obtained NPC materials showed a sponge-like texture with pores covering surfaces of the nanoporous carbon, as depicted in FIGS. 7 and 8.

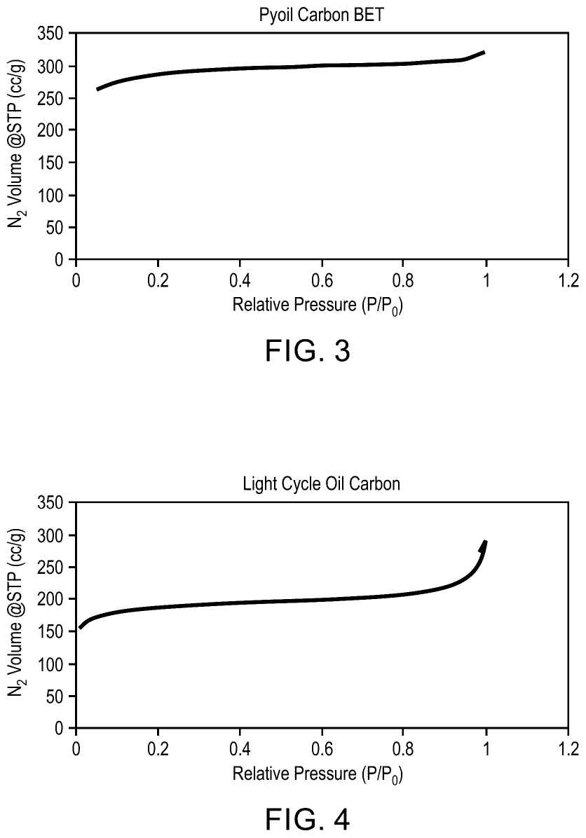

The surface area of the pyoil derived NPC material and the light cycle oil derived NPC material was around 880 m²/g and 671.6 m²/g, respectively, such as shown in FIGS. 3 and 4.

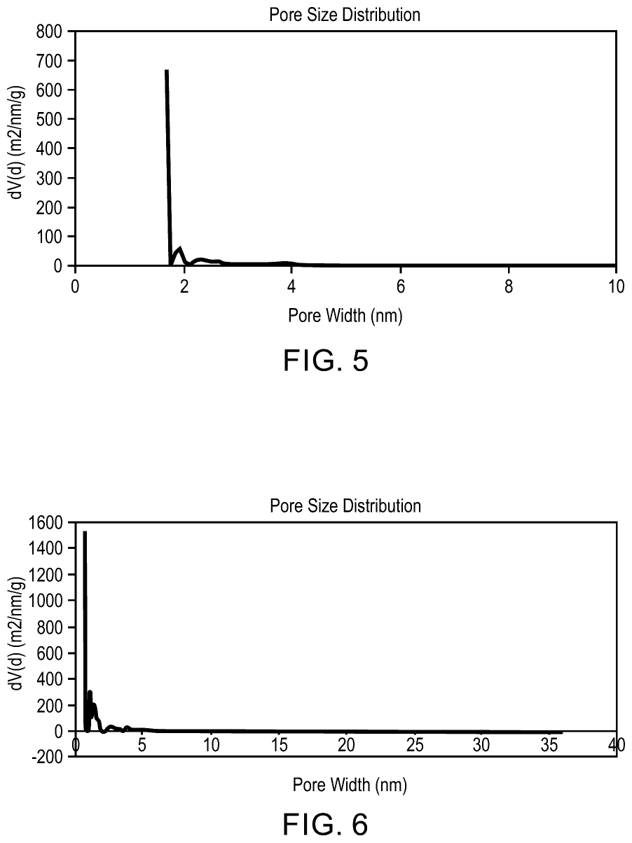

The pore size distribution of the pyoil derived NPC material and the light cycle oil derived NPC material showed the presence of micropores (≤2 nm) and mesopores (≥2 nm) as depicted in FIGS. 5 and 6.

The energy dispersive X-ray spectroscopy (EDX) results showed that the surface of pyoil derived NPC material has about 30% oxygen, in addition to elemental carbon and elemental potassium. The results of the elemental analysis of the pyoil derived NPC material were shown in Table 1 below.

TABLE 1
Elemental analysis of the pyoil derived NPC material

| Element | Net Counts | Weight % | Atom % |
|---|---|---|---|
| Carbon (C) | 16356 | 64.4 | 72.6 |
| Oxygen (O) | 1366 | 30.2 | 25.5 |
| Potassium (K) | 1128 | 5.4 | 1.9 |
| Total | | 100.0 | 100.0 |

The textural properties of the pyoil derived NPC material and the light cycle oil derived NPC material were shown in Table 2 below. Not being bound to any theory, KCl can enhance the micropore surface area of the NPC materials.

TABLE 2
Textural properties of the pyoil derived NPC material
and the light cycle oil derived NPC material

| | BET | External | Micropore | | BJH |
|---|---|---|---|---|---|
| | Surface | Surface | Surface | Pore | Pore |
| | Area | Area | Area | Volume | Size |
| Sample | (m²/g) | (m²/g) | (m²/g) | (mL/g) | (nm) |
| Pyoil derived | 879.8 | 80.04 | 799.8 | 0.498 | 1.432 |
| NPC material | | | | | |
| LCO derived | 671.6 | 194.4 | 477.2 | 0.5465 | 1.424 |
| NPC material | | | | | |

### Example 6: Carbon Dioxide (CO₂) Adsorption Test

Carbon dioxide (CO₂) adsorption test was conducted on the NPC materials to examine their applications as solid sorbents. The NPC material was first placed on a tray. The tray was then transferred into a reactor charged with a CO₂-containing gas stream. The NPC material was allowed to saturate and absorb CO_{2 from} the CO₂-containing gas stream. The temperature and pressure of the reactor can be controlled in order to determine the CO₂ uptake capacity of the NPC materials of the present disclosure.

FIG. 9 showed the CO₂ sorption isotherm of the pyoil derived NPC material at 0° C. (273 K) and 25° C. (298 K). The results indicated that the pyoil derived NPC material has a CO₂ uptake capacity of 3.2 mmol/g. Additionally, the heat of CO₂ adsorption was determined to be 23.7 kJ/mol. FIG. 10 showed the CO₂ sorption isotherm of the light cycle oil (LCO) derived NPC material at 0° C. (273 K) and 25° C. (298 K).

FIG. 10 illustrated the adsorption kinetics of the NPC material derived from a pyrolysis oil compared to a Zeolite 13× carbon sorbent. The pyoil oil derived NPC material showed an increased adsorption rate during the first 10 minutes of testing and a higher CO₂ uptake capacity compared to the Zeolite 13× sorbent.

### Embodiments

Certain embodiments of this disclosure can be implemented as a method for capturing and releasing carbon dioxide (CO₂). A nanoporous carbon (NPC) material is contacted with a CO₂-containing gas stream, thereby at least partially absorbing CO₂ in the form of molecules on surfaces and pores of the NPC material to form a sample. The NPC material is prepared from one or more low fixed carbon feeds selected from the group consisting of a pyrolysis oil, a light cycle oil, a heavy cycle oil, an Arab light crude oil, an Arab extra light crude oil, a natural gas fluid, and mixtures thereof. The CO₂ is released from the sample by thermally heating the sample or exposing the sample to a pressure swing adsorption (PSA) unit, and then the CO₂ is collected.

An aspect combinable with any other aspect can include the following features. The NPC material is in contact with the CO₂-containing gas stream at a temperature of about 0 to about 25° C.

An aspect combinable with any other aspect can include the following features. The NPC material is in contact with the CO₂-containing gas stream at a pressure of about 1 to about 800 atmospheric pressure (Po).

An aspect combinable with any other aspect can include the following features. The NPC material contains about 50 to about 90 wt. % of carbon, about 10 to about 50 wt. % of oxygen, and about 0.001 to about 10 wt. % of one or more alkali metals and alkali earth metals, as determined by energy dispersive X-ray spectroscopy (EDX).

An aspect combinable with any other aspect can include the following features. The one or more alkali metals and alkali earth metals are selected from the group consisting of lithium, sodium, potassium, rubidium, cesium, francium, beryllium, magnesium, calcium, strontium, barium, radium, and mixtures thereof.

An aspect combinable with any other aspect can include the following features. The NPC material contains about 64.4 wt. % of carbon, about 30.2 wt. % of oxygen, and about 5.4 wt. % of potassium.

An aspect combinable with any other aspect can include the following features. The NPC material has a hierarchical pore structure including mesopores and nanopores.

An aspect combinable with any other aspect can include the following features. The NPC material has a Barrett-Joyner-Halenda (BJH) pore size of about 1 nanometers (nm) to about 2 nm.

An aspect combinable with any other aspect can include the following features. The NPC material has an average pore volume of about 0.2 to about 0.9 milliliters per gram (mL/g).

An aspect combinable with any other aspect can include the following features. The NPC material has a Brunauer-Emmett-Teller (BET) surface area of about 450 to about 1050 square meters per gram (m²/g).

An aspect combinable with any other aspect can include the following features. The NPC material has a CO₂ uptake capacity of about 0.1 to about 7 millimoles of CO₂ per gram of the NPC material (mmol/g) at a temperature of about 25° C.

An aspect combinable with any other aspect can include the following features. The NPC material has less than about 0.05 wt. % of weight loss at a temperature of up to about 400° C. in an oxygen atmosphere.

An aspect combinable with any other aspect can include the following features. The thermally heating the sample is carried out at a temperature of about 30 to about 150° C.

An aspect combinable with any other aspect can include the following features. The exposing the sample to the PSA unit is carried out under a reduced pressure condition, thereby releasing the CO₂ from the NPC material.

An aspect combinable with any other aspect can include the following features. The NPC material is prepared. A mixture is formed by mixing the one or more low fixed carbon feeds and one or more metal salts. The mixture is heated at a temperature of about 400 to about 800° C. in an inert atmosphere to form a crude material. The crude material is washed with water and dried.

An aspect combinable with any other aspect can include the following features. The one or more metal salts are compounds having a formula X-Y, in which X is a metal cation selected from the group consisting of potassium, calcium, and sodium, and Y is an anion selected from the group consisting of fluoride, chloride, bromide, acetate, oxalate, carbonate, and bicarbonate.

An aspect combinable with any other aspect can include the following features. The one or more metal salts contain potassium carbonate and potassium chloride.

An aspect combinable with any other aspect can include the following features. A weight ratio of the one or more low fixed carbon feeds and the one or more metal salts is in a range of about 10:1 to about 1:5.

An aspect combinable with any other aspect can include the following features. The weight ratio of the one or more low fixed carbon feeds and the one or more metal salts is about 1:2.

An aspect combinable with any other aspect can include the following features. The mixture is heated at a temperature of about 600 to about 700° C. in the inert atmosphere.

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “particle size” and “pore size” are thought of as the lengths or longest dimensions of a particle and of a pore opening, respectively.

As used herein, the terms “room temperature” or “ambient temperature” refer to a temperature in a range of 25 degrees Celsius (C)±3° C. in the present disclosure.

As used herein, the term “atmospheric pressure” refers to the pressure exerted by the weight of air in the atmosphere of Earth. The standard atmosphere is a unit of pressure defined as about 101325 Pa (or about 1.01325 bar), equivalent to about 760 mmHg (torr), or about 29.92 in Hg and about 14.696 psi in the present disclosure.

As used herein, the term “uniform shape” refers to an average consistent shape that differs by no more than about 10%, such as by no more than about 5%, by no more than about 4%, by no more than about 3%, by no more than about 2%, or by no more than about 1% of the distribution of particles having a different shape.

As used herein, the term “non-uniform shape” refers to an average consistent shape that differs by more than about 10%, such as more than about 15%, more than about 20%, or more than about 30% of the distribution of particles having a different shape.

As used herein, the term “inert atmosphere” refers to a gaseous environment that includes non-reactive gases (i.e., that do not decompose under the action of UV) such as, for example, Ar, He, Xe, Kr, N₂, and Ar.

As used herein, the term “crude oil” refers to petroleum extracted from geologic formations in its unrefined form. Crude oil suitable as the source material for the processes herein include Arabian Heavy, Arabian Light, Arabian Extra Light, other Gulf crudes, Brent, North Sea crudes, North and West African crudes, Indonesian, Chinese crudes, or mixtures thereof. The crude petroleum mixtures can be whole range crude oil or topped crude oil. As used herein, “crude oil” also refers to such mixtures that have undergone some pre-treatment such as water-oil separation; and/or gas-oil separation; and/or desalting; and/or stabilization. In certain cases, crude oil refers to any of such mixtures having an API gravity (ASTM D287 standard), of greater than or equal to about 20°, 30°, 32°, 34°, 36°, 38°, 40°, 42° or 44°.

As used herein, Arab extra light crude oil is characterized by an API gravity of greater than or equal to about 38°, 40°, 42° or 44°, and in certain cases in the range of about 38°-46°, 38°-44°, 38°-42°, 38°-40.5°, 39°-46°, 39°-44°, 39°-42° or 39°-40.5°.

As used herein, Arab light crude oil (acronym “AL” or “AR”) is characterized by an API gravity of greater than or equal to about 30°, 32°, 34°, 36° or 38°, and in certain cases in the range of about 30°-38°, 30°-36°, 30°-35°, 32°-38°, 32°-36°, 32°-35°, 33°-38°, 33°-36° or 33°-35°.

The terms “pyrolysis oil” and its abbreviated form “pyoil” are used herein having their well-known meaning, that is, a heavy oil fraction, C10+, that is derived from steam cracking.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

1. A method for capturing and releasing carbon dioxide (CO₂), comprising:
contacting a nanoporous carbon (NPC) material with a CO₂-containing gas stream, thereby at least partially absorbing CO₂ in the form of molecules on surfaces and pores of the NPC material to form a sample, wherein the NPC material is prepared from one or more low fixed carbon feeds selected from the group consisting of a pyrolysis oil, a light cycle oil, a heavy cycle oil, an Arab light crude oil, an Arab extra light crude oil, a natural gas fluid, and mixtures thereof;
releasing the CO₂ from the sample by thermally heating the sample or exposing the sample to a pressure swing adsorption (PSA) unit; and
collecting the CO₂.

2. The method of claim 1, wherein the NPC material is in contact with the CO₂-containing gas stream at a temperature of about 0 to about 25° C.

3. The method of claim 1, wherein the NPC material is in contact with the CO₂-containing gas stream at a pressure of about 1 to about 800 atmospheric pressure (Po).

4. The method of claim 1, wherein the NPC material comprises about 50 to about 90 wt. % of carbon, about 10 to about 50 wt. % of oxygen, and about 0.001 to about 10 wt. % of one or more alkali metals and alkali earth metals, as determined by energy dispersive X-ray spectroscopy (EDX).

5. The method of claim 4, wherein the one or more alkali metals and alkali earth metals are selected from the group consisting of lithium, sodium, potassium, rubidium, cesium, francium, beryllium, magnesium, calcium, strontium, barium, radium, and mixtures thereof.

6. The method of claim 4, wherein the NPC material comprises about 64.4 wt. % of carbon, about 30.2 wt. % of oxygen, and about 5.4 wt. % of potassium.

7. The method of claim 1, wherein the NPC material has a hierarchical pore structure comprising mesopores and nanopores.

8. The method of claim 1, wherein the NPC material has a Barrett-Joyner-Halenda (BJH) pore size of about 1 nanometers (nm) to about 2 nm.

9. The method of claim 1, wherein the NPC material has an average pore volume of about 0.2 to about 0.9 milliliters per gram (mL/g).

10. The method of claim 1, wherein the NPC material has a Brunauer-Emmett-Teller (BET) surface area of about 450 to about 1050 square meters per gram (m²/g).

11. The method of claim 1, wherein the NPC material has a CO₂ uptake capacity of about 0.1 to about 7 millimoles of CO₂ per gram of the NPC material (mmol/g) at a temperature of about 25° C.

12. The method of claim 1, wherein the NPC material has less than about 0.05 wt. % of weight loss at a temperature of up to about 400° C. in an oxygen atmosphere.

13. The method of claim 1, wherein the thermally heating the sample is carried out at a temperature of about 30 to about 150° C.

14. The method of claim 1, wherein the exposing the sample to the PSA unit is carried out under a reduced pressure condition, thereby releasing the CO₂ from the NPC material.

15. The method of claim 1, further comprising preparing the NPC material by:
mixing the one or more low fixed carbon feeds and one or more metal salts to form a mixture;
heating the mixture at a temperature of about 400 to about 800° C. in an inert atmosphere to form a crude material; and
washing the crude material with water and drying.

16. The method of claim 15, wherein the one or more metal salts are compounds having a formula X-Y, wherein X is a metal cation selected from the group consisting of potassium, calcium, and sodium, and wherein Y is an anion selected from the group consisting of fluoride, chloride, bromide, acetate, oxalate, carbonate, and bicarbonate.

17. The method of claim 16, wherein the one or more metal salts comprise potassium carbonate and potassium chloride.

18. The method of claim 15, wherein a weight ratio of the one or more low fixed carbon feeds and the one or more metal salts is in a range of about 10:1 to about 1:5.

19. The method of claim 18, wherein the weight ratio of the one or more low fixed carbon feeds and the one or more metal salts is about 1:2.

20. The method of claim 15, wherein the mixture is heated at a temperature of about 600 to about 700° C. in the inert atmosphere.
